(19) United States
(12) Patent Application Publication
(10) Pub. No.: US 2017/0090606 A1
(43) Pub. Date: Mar. 30, 2017

(54) MULTI-FINGER TOUCH

(71) Applicant: Polycom, Inc., San Jose, CA (US)

(72) Inventors: Konstantin Pirogov, Coquitlam (CA); Simon Moret, Port Moody (CA)

(21) Appl. No.: 14/871,012

(22) Filed: Sep. 30, 2015

(51) Int. Cl. G06F 3/041

(52) U.S. Cl. CPC G06F 3/041; G06F 2203/04104

(57) ABSTRACT

A multi-finger touch (e.g., a simultaneous touch of two or more touch-sensitive regions of a touchpad or touchscreen by three or more objects) that causes a touch-sensitive device to perform a function (e.g., open an application control program, open a device control menu, and/or interrupt a startup process and perform a function other than launching the operating system in the normal mode).

### INVENTIVE FIELD

This disclosure relates generally to controlling a touch-sensitive device and more specifically to controlling a touch-sensitive device using a multi-finger touch.

### BACKGROUND

Touchscreen input devices provide a user interface that is both intuitive and flexible. The user interface is intuitive because the user is given the impression of directly manipulating graphical elements shown on the display. The user interface is flexible because input methods may change depending on an application or application mode. For example, a touchscreen may display a virtual desktop with icons that may be directly selected, a virtual keyboard with most or all keys typically included in a QWERTY keyboard, a virtual keypad with most or all keys typically included in a telephone, etc.

Touchscreen input devices are limited, however, because visually displaying all of the available options to the user takes up valuable on-screen real estate. While some touchscreen devices overcome this deficiency by allowing user to input commands using gestures, those gestures may be difficult to remember and may cause a user to unintentionally input a command.

Conventional devices with physical inputs provide users with the option of entering certain persistently-available commands regardless of the application or application mode. A user of a desktop computer with a QWERTY keyboard, for example, may interrupt most computing processes by pressing the Delete key while holding the Control and Alt keys. Most touchscreen input devices, however, have a limited number of physical inputs, reducing the number of persistently-available commands that may be input.

Some software applications have special modes that are not apparent or hidden from the user. Desktop computers, for example, may start up in safe mode or run a setup utility if certain keys are entered during startup. In another example, a console video game may include a hidden mode that is activated by a combination entered via the game controller (e.g., the Konami code).

Accordingly, there is a need to control a touch-sensitive device in a way that is easy for a user to remember and execute properly (regardless of what, if anything, is displayed on a screen), easy for the device to recognize, unlikely to be unintentionally performed by a user, and eliminates the need for an additional physical input.

### SUMMARY

According to an exemplary embodiment, there is provided a touch-sensitive device configured to recognize a multi-finger touch. The multi-finger touch may be a simultaneous touch of two or more touch-sensitive regions of a touchpad or touchscreen by three or more objects. In response to a multi-finger touch, the device may open an application control program, open a device control menu, and/or interrupt a startup process and perform a function other than launching the operating system in the normal mode (e.g., perform a factory reset, launch the operating system in a diagnostic mode, launch a start-up utility, etc.).

According to other exemplary embodiments, there is provided a graphical user interface (GUI) for a touch-sensitive device, a method implemented by a touch-sensitive device, and a computer-readable storage medium including instructions that may be implemented by a touch-sensitive device.

### BRIEF DESCRIPTION OF THE DRAWINGS

Exemplary embodiments may be more readily understood from reading the following description and by reference to the accompanying drawings, in which:

FIG. 1 is a top-down view of a touch-sensitive device according to an exemplary embodiment;

FIG. 2 is a block diagram of the touch-sensitive device illustrated in FIG. 1 according to an exemplary embodiment;

FIG. 3A illustrates a multi-finger touch according to an exemplary embodiment;

FIG. 3B illustrates a multi-finger touch according to another exemplary embodiment;

FIG. 3C illustrates a multi-finger touch according to another exemplary embodiment;

FIG. 3D illustrates a multi-finger touch according to another exemplary embodiment;

FIG. 3E illustrates the device illustrated in FIGS. 1-2 according to another exemplary embodiment;

FIGS. 3F and 3G illustrate successive multi-finger touches according to an exemplary embodiment;

FIGS. 4A and 4B area flowcharts illustrating typical use cases according to exemplary embodiments; and

FIG. 5 is a flowchart illustrating a typical use case according to another exemplary embodiment.

### DETAILED DESCRIPTION

Exemplary embodiments of the present invention will be set forth in detail with reference to the drawings, in which like reference numerals refer to like elements or steps throughout.

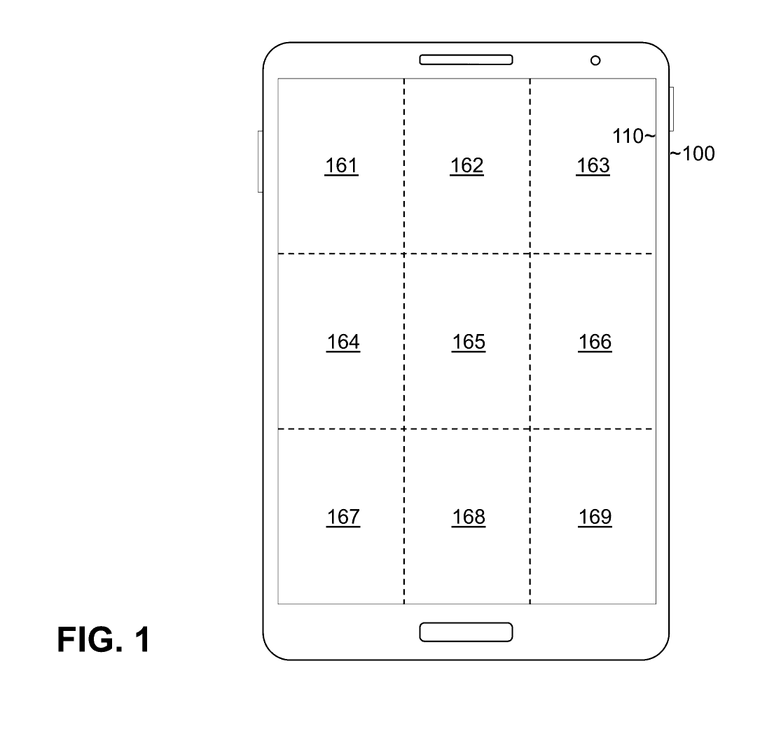

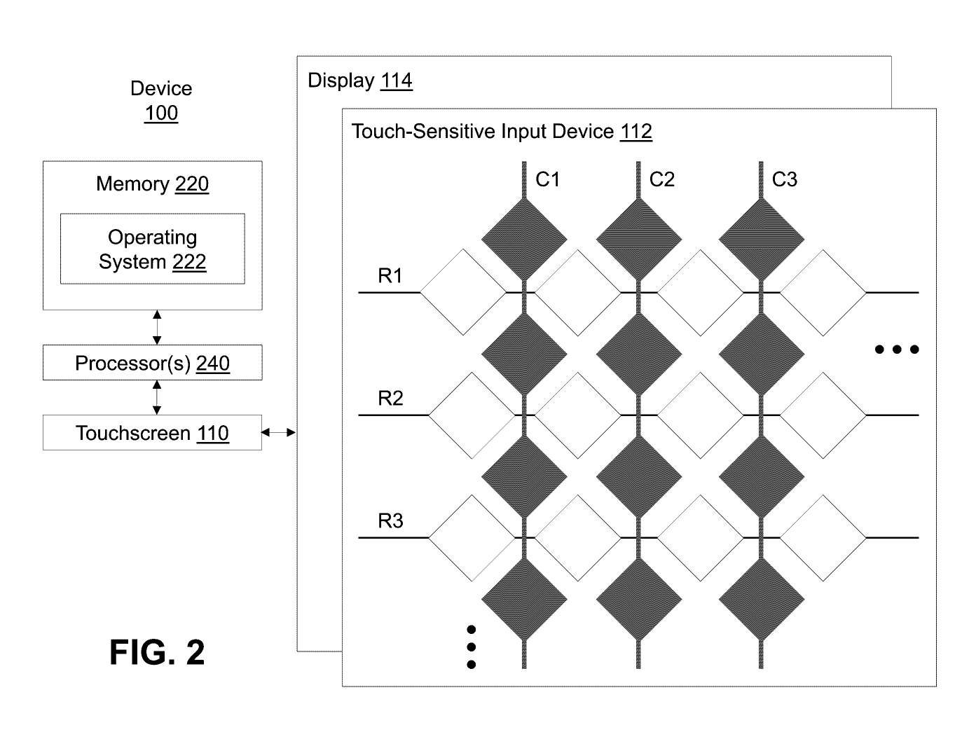

FIG. 1 is a top-down view of a touch-sensitive device 100 including a touchscreen 110 according to an exemplary embodiment. FIG. 2 is a block diagram of the touch-sensitive device 100 illustrated in FIG. 1 according to an exemplary embodiment. The touch-sensitive device 100 includes memory 220 and one or more processors 240. The memory stores programs, including an operating system 222, executable by the processor(s) 240. The touch-sensitive device 100 includes a touch-sensitive input 112 overlaid on or integrated with a display 114. The touchscreen 110 may include a plurality of touch-sensitive regions (e.g., nine regions 161-169 as shown in FIG. 1) and the touch-sensitive device 100 may be configured to recognize a multi-finger touch and perform a function in response to a specific multi-finger touch.

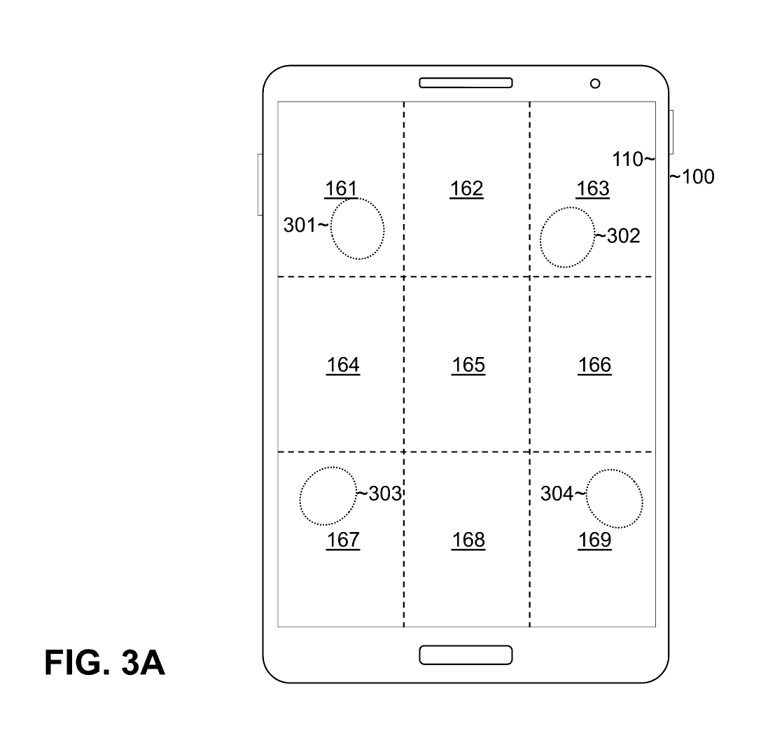

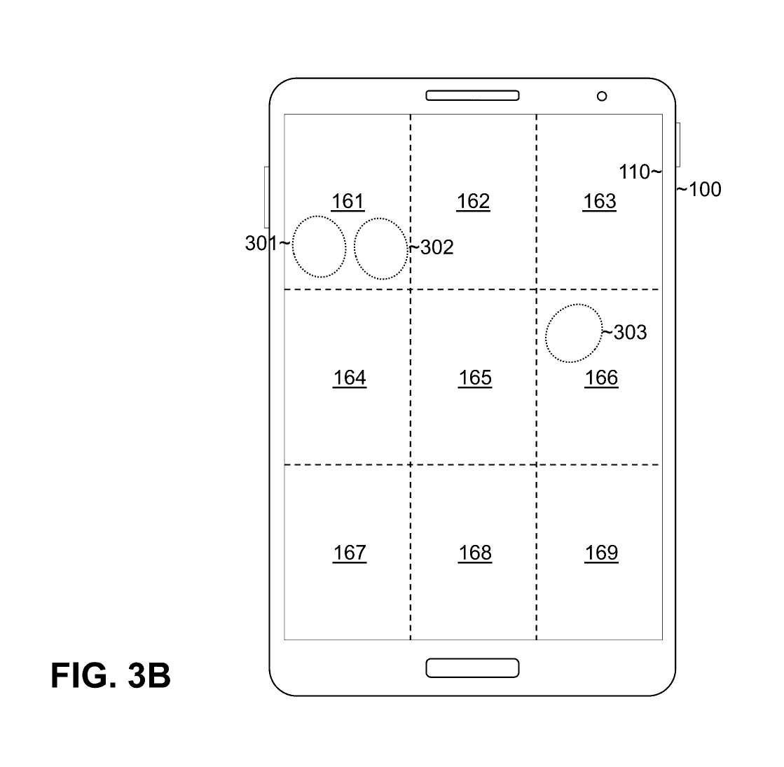

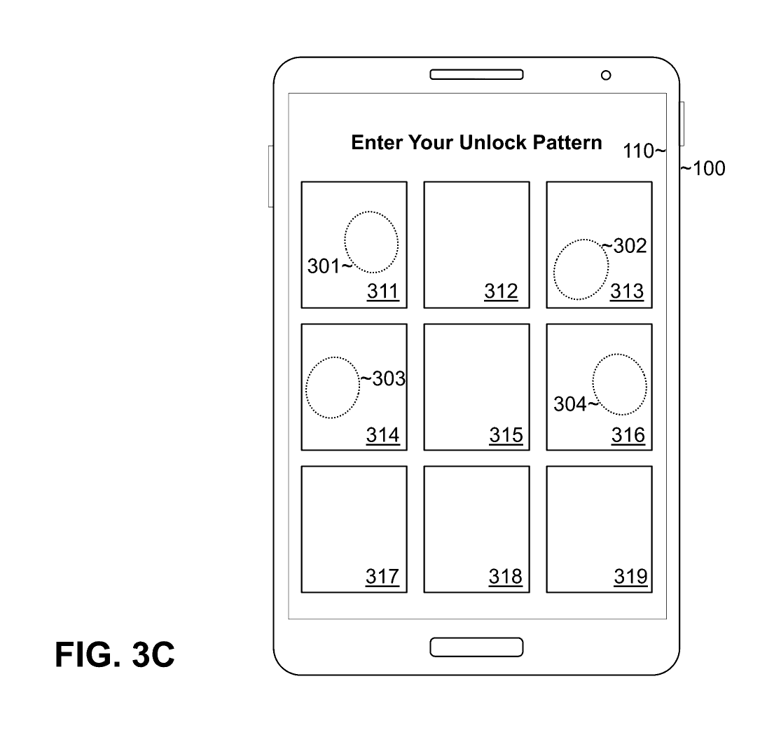

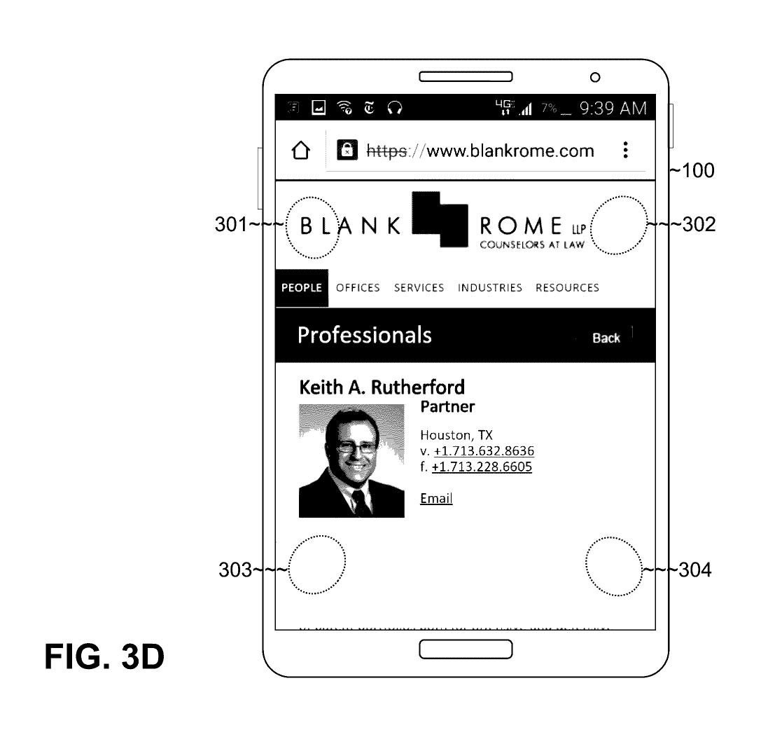

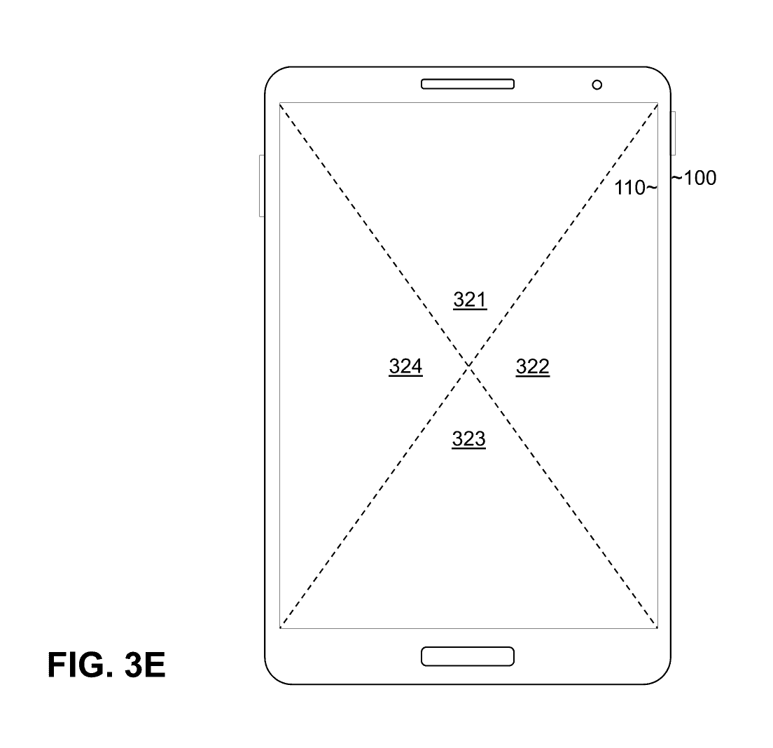

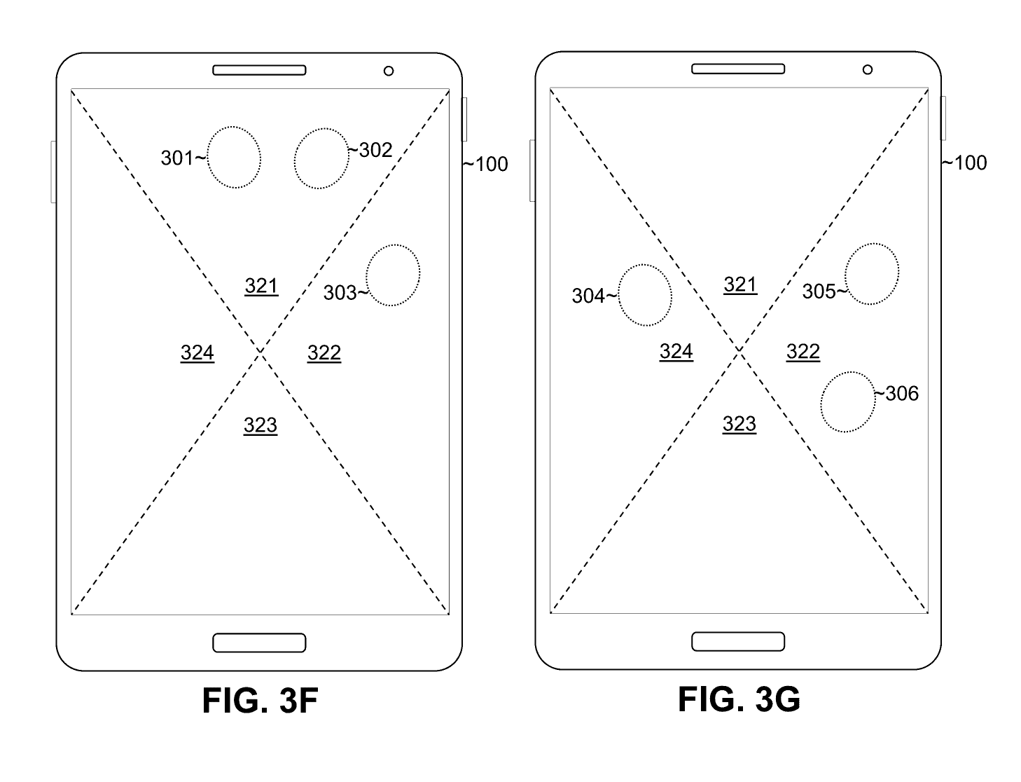

As used herein, “a multi-finger touch” may include the touching of more than one touch-sensitive region by three or more fingers (and/or objects). As shown in FIG. 3A, for example, the touchscreen 110 may include touch-sensitive regions 161-169 and the touch-sensitive device 100 may be configured to perform a function in response to, for example, a four-finger touch 301-304 in regions 161, 163, 167, and 169.

The touch-sensitive device 100 may be configured to recognize a multi-finger touch that includes more than one finger in the same touch-sensitive region. As shown in FIG. 3B, for example, the touchscreen 110 may include touch-sensitive regions 161-169 and the touch-sensitive device 100 may be configured to perform a function in response to, for example, a two-finger touch 301 and 302 in region 161 and a one finger touch 303 in region 166.

In some embodiments, the touch-sensitive regions may be visible to the user. As shown in FIG. 3C, for example, the touchscreen 110 may output an image indicative of the boundaries of each of the touch-sensitive regions 312-319 and the touch-sensitive device 100 may be configured to perform a function in response to, for example, a four-finger touch 301-304 in regions 311, 313, 314, and 316.

In other embodiments, the touch-sensitive regions may be invisible (whether there is a display on the screen or if the screen appears to be off). As shown in FIG. 3D, for example, the touch-sensitive device 100 may be configured to recognize a multi-finger touch in the regions 161-169 illustrated in FIGS. 3A-3B (e.g., a four-finger touch 301-304 in regions 161, 163, 167, 169). As illustrated in FIG. 3D, however, the touch-sensitive device 100 may recognizing a multi-finger touch in a number of specific touch-sensitive regions 161-169 without indicating the boundaries of the touch-sensitive regions 161-169 via the display 114. Accordingly, the touch-sensitive device 100 may provide a user with the ability to control the touch-sensitive device 100 without occupying any of the limited space on the touchscreen 110.

The touchscreen 110 of the touch-sensitive device 100 may include any number of touch-sensitive regions. The touch-sensitive regions may be substantially the same shape and substantially equal in size. Alternatively, the touch-sensitive regions may have different shapes and/or may have varying sizes. As illustrated in FIG. 3E, for example, the touchscreen may include four triangular touch-sensitive regions 321-324.

The touch-sensitive device 100 is configured to distinguish between a multi-finger touch, a single-finger (or single-object) touch, and a gesture. For example, if one or more fingers (or objects) move across the touchscreen 110, the touch-sensitive device 100 makes the determination that the input is a gesture. Additionally, if one or more fingers or objects is/are stationary (i.e., within a predetermined distance threshold), the touch-sensitive device 100 may wait until the finger(s) or object(s) is/are lifted off the touchscreen 110 before making a determination that the user has input is a single-finger touch (or single-object touch). Therefore, a user may touch the touchscreen 110 with multiple fingers in succession without the touch-sensitive device 100 incorrectly interpreting the input as a single-finger touch or gesture. The touch sensitive device 100 may perform a function in response to a multi-finger touch as soon as the multi-finger touch is recognized or when the user's fingers are lifted off the screen.

The touch-sensitive device 100 may be configured to perform a function in response to a multiple multi-finger touches in succession. As illustrated in FIGS. 3F and 3G, the touchscreen 110 may include touch-sensitive regions 321-324 and the touch-sensitive device 100 may be configured to perform a function in response to, for example, a two-finger touch 301 and 302 in region 321 and a one-finger touch 303 in region 322 followed by a one-finger touch 304 in region 324 and a two-finger touch in region 322.

The function performed by the touch-sensitive device 100 in response to the multi-finger touch may include interrupting a function being performed by the touch-sensitive device 100, outputting a menu of functions to the user, etc.

In one embodiment, the touch-sensitive device 100 may perform a function in response to a multi-finger touch regardless of the current state of the operating system 222 or application running in the foreground of the touch-sensitive device 100. For example, the operating system touch-sensitive device 100 may open an application control program in response to a multi-finger touch. Similar to the task manager or the menu output by a desktop computer in response to a Ctrl+Alt+Delete command, the application control program may enable the user to switch applications, terminate or launch applications and/or processes, view information regarding applications and/or processes running on the touch-sensitive device 100 (or recently terminated), etc.

In another example, the operating system 222 may open a device control menu in response to a multi-finger touch regardless of the current state of the operating system 222 or application running in the foreground of the touch-sensitive device 100. Similar to the Android pull down menu or iOS pull up menu, the device control menu may enable the user to turn on/off certain hardware functionality (e.g., Wi-Fi, Bluetooth, near field communication, location services, etc.), put the touch-sensitive device 100 in a certain mode (e.g., airplane mode, power saving mode, car mode, private mode, do not disturb mode, etc.), change output settings (e.g., sound/vibrate/silent, screen rotation, etc.), monitor the performance of hardware components of the touch-sensitive device 100, launch applications, etc.

By opening an application control program and/or device control menu regardless of the application running in the foreground, the embodiments described above provide the user with an ever-present ability to control the touch-sensitive device 100.

In order to make it easier for users to remember the specific regions that cause the touch-sensitive device 100 to perform a certain function, the regions may be selected based on their proximity to the positions of keys of a standard QWERTY keyboard. For example, in order to perform a function that is analogous to a function performed by a desktop computer in response to a Ctrl+Alt+Delete command, the touch-sensitive device 100 may be configured to respond to a multi-finger touch of region 167 (which, similar to the Ctrl key of a QWERTY keyboard, is in the bottom left corner) along with region 168 (which is in a similar position as the Alt key of a QWERTY keyboard) and region 163 (which, similar to the Delete key of a QWERTY keyboard, is in the top-right corner). The specific regions that cause the touch-sensitive device 100 to perform specific functions may depend on the orientation of the touch-sensitive device 100. For example, when the touch-sensitive device 100 is used in a landscape orientation, selecting regions 169 (bottom-left), 166, and 161 (top-right) may cause the touch-sensitive device 100 to perform the function analogous the Ctrl+Alt+Delete function.

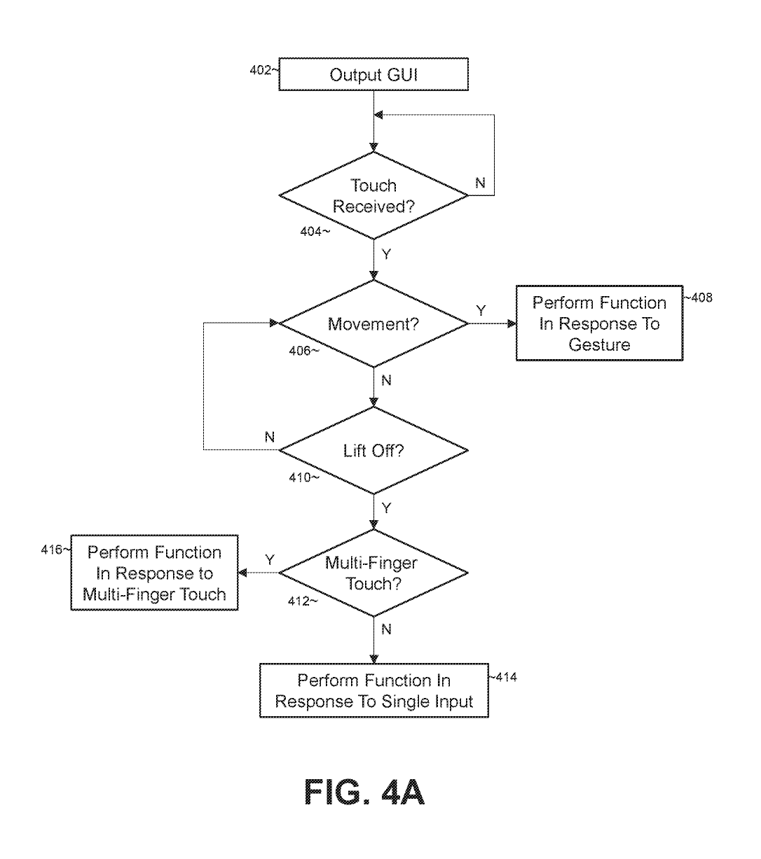

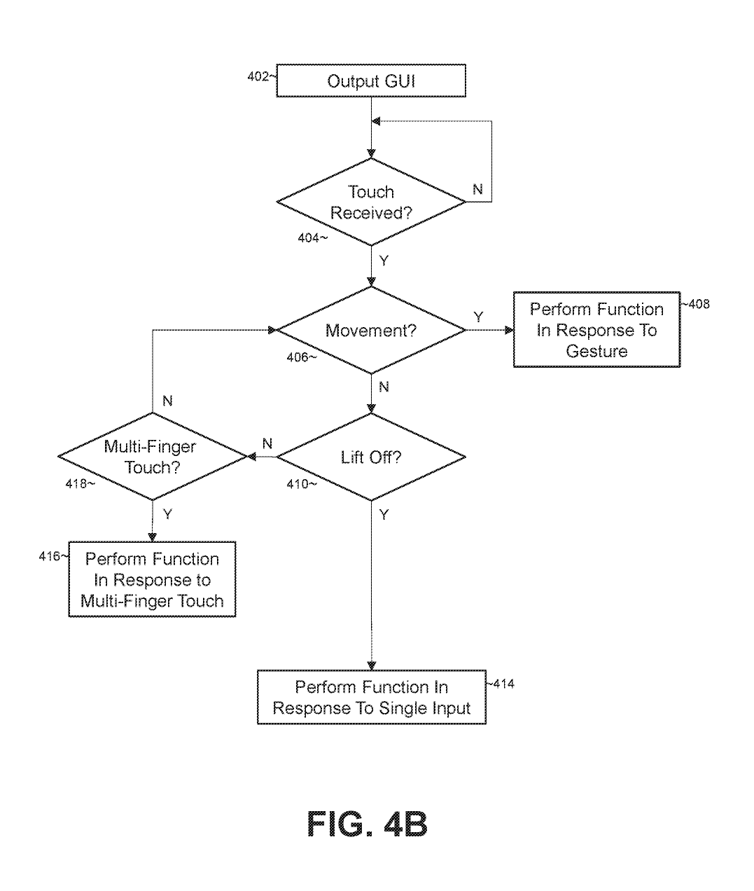

FIG. 4A is a flowchart illustrating a typical use case for the touch-sensitive device 100 according to an exemplary embodiment. The touch-sensitive device 100 outputs a graphical user interface (GUI) via the display 114 of the touch-sensitive device 100 in operation 402. As described above, the touchscreen 110 may or may not output an image indicative of the boundaries of the touch-sensitive regions. The touch-sensitive device 100 determines whether an input is received in operation 404. In operation 406, the touch-sensitive device 100 determines whether the object(s) or finger(s) making contact with the touchscreen 110 is/are moving (i.e., whether the object(s) or finger(s) move within a predetermined distance threshold.) If the touch-sensitive device determines that the object(s) or finger(s) is/are moving, the touch-sensitive device 100 performs a function in response to the gesture in operation 408.

If the object(s) or finger(s) making contact with the touchscreen 110 is/are stationary, the touch-sensitive device 100 determines whether the object(s) or finger(s) lift off from the touchscreen 110 in operation 410. If not, the touch-sensitive device 100 repeatedly determines whether the object(s) or finger(s) move (operation 406) or lift off (operation 410) before performing a function. Accordingly, a user may touch the touchscreen 110 with multiple fingers in succession without the touch-sensitive device 100 incorrectly interpreting the input as a single-finger touch or gesture. Once the object(s) or finger(s) lift off the touchscreen, the touch-sensitive device 100 determines whether the input is a multi-finger touch in operation 412. If the input is a multi-finger touch, the touch-sensitive device 100 performs a function in response to the multi-finger touch in operation 416. Otherwise, the touch-sensitive device 100 responds to the single-finger (or single-object) touch in operation 414.

FIG. 4B is a flowchart illustrating a typical use case another exemplary embodiment. The use case illustrated in FIG. 4B is identical to the use case illustrated in FIG. 4A except that the touch-sensitive device 100 repeatedly determines whether the object(s) or finger(s) move (operation 406) or lift off (operation 410) or whether the object(s) or finger(s) form a multi-finger touch (operation 418). Accordingly, if a user inputs a multi-finger touch in operation 418, the touch-sensitive device 100 performs a function in response to the multi-finger touch without the user having to first lift remove the fingers from the touchscreen.

Some conventional touchscreen devices may provide some of the functionality described above in response to a gesture. (For example, a conventional touchscreen may open a device control menu in response to a swipe gesture beginning at an edge or corner of a touchscreen or may take a screen shot in response to an edge of a user's hand sweeping across the touchscreen.) Gestures, however, can have significant drawbacks. A gesture may interfere with the functionality of an application running in a foreground. (For example, a user may unintentionally open a device control menu when using a drawing program near the edge of the touchscreen.) Also, a user may unintentionally perform a function if the gesture is not input correctly. (For example, a user may pan or zoom when attempting to take a screenshot.) Finally, gestures that are used infrequently can be difficult for users to remember.

A multi-finger static touch, by contrast, is easy for a user to remember and execute properly, easy for the touch-sensitive device 100 to recognize, and unlikely to be unintentionally performed by a user.

Some conventional touchscreen devices may provide some of the functionality described above in response to user manipulation of a physical input. (For example, a conventional touchscreen device may allow a user to switch applications by pressing and holding a home button.) A multi-finger touch, by contrast, reduces size and cost of the touch-sensitive device 100 by eliminating the need for an additional physical input.

In some embodiments, the touch-sensitive device 100 may be configured to recognize a multi-finger touch when the display 114 is turned off. In some embodiments, the processor(s) 240 may be configured to recognize a multi-finger touch via the touch-sensitive input device 112 even when the touch-sensitive device is in sleep mode.

In another embodiment, the operating system 222 may perform a context-specific function or open a context-specific menu in response to a multi-finger touch. The context-specific menu may offer the user a set of options based on the current state of the operating system 222 or application running in the foreground of the touch-sensitive device 100.

In another embodiment, an application running in the foreground of the touch-sensitive device 100 may perform a function or output a menu of functions in response to a multi-finger touch. For example, the touch-sensitive device 100 may recognize a multi-finger touch input while a user is playing a game and the game may enable the user to play the game in a specific mode.

In another embodiment, in response to a multi-finger, the touch-sensitive device 100 may change a set of virtual keys output via the touchscreen 110 in a manner similar to when a user holds down an Alt key using a conventional desktop keyboard.

In another embodiment, the touch-sensitive device 100 may interrupt a startup sequence in response to a multi-finger touch input during startup and perform a function in response to a multi-finger touch. Even before the display 114 outputs an image during startup, the processor(s) 240 may be configured to may be configured to recognize a multi-finger touch touch-sensitive input device 112, interrupt the startup sequence, and perform a function. For example, the touch-sensitive device 100 may perform a factory reset, launch the operating system 222 in a safe mode or diagnostic mode, output a menu for the user to select one or more of the aforementioned functions, etc. Again, while some conventional devices may provide this functionality in response to user manipulation of a physical input, recognition of a multi-finger touch reduces the size and cost of the touch-sensitive device 100 by eliminating the need for a physical input to provide this functionality. Eliminating the need for an additional physical input may be particularly advantageous for smaller touch screen devices such as smart watches.

In another embodiment, the touch-sensitive device 100 may be a large format display such as an interactive whiteboard. In response to a multi-finger finger touch (that may include fingers from multiple hands), the touch-sensitive device 100 may perform a function such as sharing content with another device or outputting a menu to share content with another device.

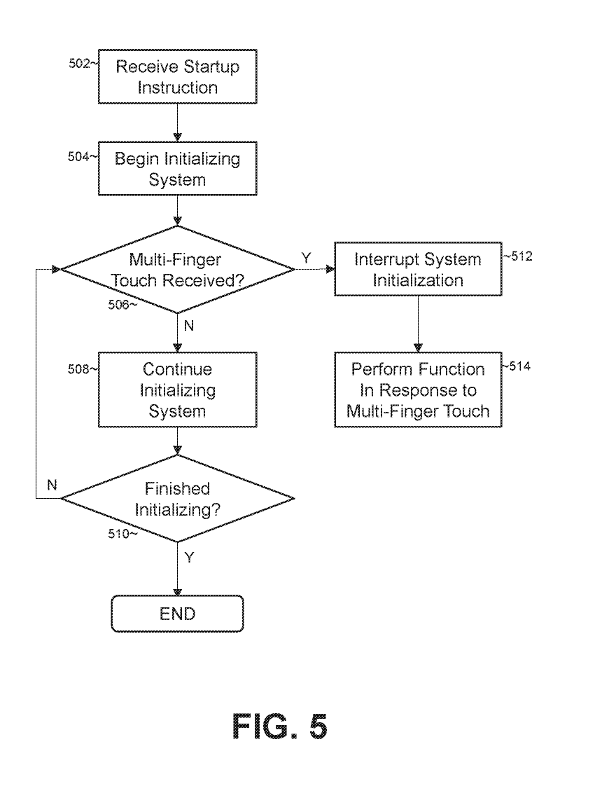

FIG. 5 is a flowchart illustrating a typical use case for the device 100 according to another exemplary embodiment. The touch-sensitive device 100 receives an instruction to begin a startup sequence in operation 502. For example, electrical power to the CPU may be switched from off to on (i.e., a “hard” boot) or the instruction may be received via hardware such as a button press or by a software command (i.e., a “soft” boot). System initialization begins in operation 504. System initialization may include one or more self-tests, locating and initializing peripheral devices, and/or finding, loading and starting the operating system 222. In operation 506, the touch-sensitive device 100 determines whether a multi-finger touch is received. If not, system initialization continues in operation 508. In some embodiments, the touch-sensitive device 100 may repeatedly determine if a multi-finger touch has been input during the startup sequence until a determination is made that the system initialization is complete in operation 510. If the touch-sensitive device 100 determines that a multi-finger touch is received, system initialization is interrupted in operation 512 and the touch-sensitive device 100 performs a function in response to the multi-finger touch in operation 514.

While FIG. 2 illustrates touch-sensitive device 100 that includes a display 114, those skilled in the art will recognize that exemplary embodiments may be implemented by a touchpad device that includes a touch-sensitive input 112 without a display.

While FIG. 2 illustrates a touch-sensitive device 100 that includes a touch-sensitive input 112, processor(s) 240, and memory 220, those skilled in the art will recognize that exemplary embodiments may implemented by a touch-sensitive peripheral device that sends/receives data to/from an external computing device includes the processor(s) 240 and memory 222 described herein.

The touch-sensitive device 100 may be any suitable device configured to receive input from a user. The touch-sensitive device 100 may be, for example, a smartphone, a tablet computer, a notebook or desktop computer, a GPS receiver, a personal digital assistant (PDA), etc. The touch-sensitive device 100 may provide touch input capability for a video conferencing system, a vehicle (such as a car, a ship, an airplane, a satellite truck, etc.), an appliance, a home or other building, etc.

The touch-sensitive input 112 may include any suitable technology to determine the location of more than one finger or object relative to the touch-sensitive device 100. The touch-sensitive input 112 may be, for example, a mutual capacitive touch sensor pad that includes a capacitor at each intersection of a column trace (e.g., C1, C2, etc.) and a row trace (e.g., R1, R2, etc.). A voltage is applied to the column traces or row traces. When a finger or conductive stylus is near the surface, the finger or stylus changes the local electric field which reduces the mutual capacitance. The capacitance change at every individual point on the grid can be measured to accurately determine the touch location by measuring the voltage in the other axis. For example, if a voltage is applied to column traces C1, C2, etc., the capacitive change can be measured by measuring the voltage in each of the row traces R1, R2, etc. The touch-sensitive input 112 may be overlaid or integrated with the display 114 to form a touch-sensitive display or touchscreen.

The display 114 may be any suitable device configured to output visible light, such as a liquid crystal display (LCD), a light emitting polymer display (LPD), a light emitting diode (LED) display, an organic light emitting diode (OLED) display, etc.

The memory 220 may include one or more non-transitory computer readable storage mediums. For example, the memory 220 may include high-speed random access memory and/or non-volatile memory such as one or more magnetic disk storage devices, flash memory devices, and/or other non-volatile solid-state memory, etc.

The one or more processors 240 may include a central processing unit (CPU), a graphics processing unit (GPU), controllers, peripheral controllers, etc. The processor(s) 240 may be integrated into a single semiconductor chip or may be implemented by more than one chip. The one or more processors 240 may execute various software programs and/or sets of instructions stored in the memory 220 to process data and/or to perform various functions for the touch-sensitive device 100.

The operating system 222 may be any software application that manages the hardware and software resources of the touch-sensitive device 100 and/or provides common services for computer programs stored in the memory 220 and executed by the processors(s) 240 of the touch-sensitive device 100.

While preferred embodiments have been set forth above, those skilled in the art who have reviewed the present disclosure will readily appreciate that various changes to the systems and methods disclosed herein are possible without departing from the scope of the following claims. Embodiments described separately may be combined. Process steps described in a specific order may be performed in a different order. Process steps described separately may be combined. Individual process steps may be omitted. Descriptions of hardware components and software modules are illustrative rather than limiting. Accordingly, the present disclosure should be construed as limited only by the appended claims.

What is claimed is:

1. A touch-sensitive device, comprising:
memory;
a touch-sensitive input including touch-sensitive regions; and
a processor that performs a function in response to a simultaneous touch of two or more of the touch-sensitive regions by three or more objects.

2. The device of claim 1, wherein the touch-sensitive regions are invisible.

3. The device of claim 1, wherein, in response to a touch of the touch-sensitive input by a single object, the processor first determines whether the single object breaks contact with the touch-sensitive input before performing a second function in response to the touch by the single object.

4. The device of claim 1, wherein the processor opens an application control program or a device control menu.

5. The device of claim 4, wherein the touch-sensitive device is configured to run a plurality of software applications and the application control program or device control menu is opened in response to the simultaneous touch regardless of the software application running on the touch-sensitive device.

6. The device of claim 1, wherein the function is selected based on a software application running on the touch-sensitive device.

7. A graphical user interface on a device having memory, a touch-sensitive input, and a processor, the graphical user interface comprising:
a plurality of touch-sensitive regions,
wherein a function is performed in response to a simultaneous touch of two or more of the plurality of touch-sensitive regions by three or more objects.

8. The graphical user interface of claim 7, wherein the touch-sensitive regions are invisible.

9. The graphical user interface of claim 7, wherein, in response to a touch of the touch-sensitive input by a single object, the processor first determines whether the single object breaks contact with the touch-sensitive input before performing a second function in response to the touch by the single object.

10. The graphical user interface of claim 7, wherein the function is an application control program or a device control menu.

11. The graphical user interface of claim 10, wherein the touch-sensitive device is configured to run a plurality of software applications and the application control program or device control menu is opened in response to the simultaneous touch regardless of the software application running on the touch-sensitive device.

12. The graphical user interface of claim 1, wherein the function is selected based on a software application running on the touch-sensitive device.

13. A method implemented by a device having memory, a touch-sensitive input, and a processor, the method comprising:
outputting, by the touch-sensitive input, a plurality of touch-sensitive regions;
performing a function, by the device, in response to a simultaneous touch of two or more of the touch-sensitive regions by three or more objects.

14. The method of claim 13, wherein the touch-sensitive regions are invisible.

15. The method of claim 13, further comprising:
determining whether a single object touches the touch-sensitive input;
determining whether the object no longer touches the touch-sensitive input; and
in response to a determination that the single object no longer touches the touch-sensitive input, performing a second function in response to the single object.

16. The method of claim 13, wherein function is an application control program or a device control menu.

17. The method of claim 16, wherein the application control program or device control menu is opened regardless of a software application running on the touch-sensitive device.

18. The method of claim 13, further comprising:
selecting the function based on a software application running on the touch-sensitive device.

19. A non-transitory computer readable storage medium (CRSM) storing instructions that, when executed by a processor, cause a device having a touch-sensitive input to:
output a plurality of touch-sensitive regions via the touch-sensitive input;
perform a function in response to a simultaneous touch of two or more of the touch-sensitive regions by three or more objects.

20. The CRSM of claim 19, wherein the touch-sensitive regions are invisible.

21. The CRSM of claim 19, further comprising a display that outputs an image indicative of the boundaries of the touch-sensitive regions.

22. The CRSM of claim 19, wherein function is an application control program or a device control menu.

23. The CRSM of claim 22, wherein the application control program or device control menu is opened regardless of a software application running on the touch-sensitive device.

24. The CRSM of claim 19, further comprising instructions that cause the device to:
select the function based on a software application running on the touch-sensitive device.
